(19) United States
(12) Patent Application Publication
(10) Pub. No.: US 2004/0148224 A1
(43) Pub. Date: Jul. 29, 2004

(54) Method and apparatus for electronic support and delivery of multiple lottery and sweepstake programs, in substantially off-line environments

(75) Inventors: Patrick Gauthier, Mountain View, CA (US); Jean Elizabeth Farnsworth, San Mateo, CA (US); Diane Salmon, Lafayette, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Visa U.S.A., San Francisco, CA

(21) Appl. No.: 10/401,503

(22) Filed: Mar. 27, 2003

Related U.S. Application Data
(60) Provisional application No. 60/410,880, filed on Sep. 13, 2002.

(51) Int. Cl. G06F 17/60

(52) U.S. Cl. 705/14

(57) ABSTRACT

A method for providing an instant win program during a transaction between a base device and a portable device is provided. The method comprises: establishing a connection between the portable device and the base device to initiate the transaction between the portable device and base device; determining information for the instant win program at the base device; and using the information to determine if the portable device is eligible for a prize in the instant win program during the transaction.

### CROSS-REFERENCES TO RELATED APPLICATIONS

This U.S. non-provisional application claims priority from U.S. Provisional Patent Application No. 60/410,880, filed Sep. 13, 2002, which is herein incorporated by reference in its entirety for all purposes.

The following application is also related to U.S. patent application No. ______, entitled “Network Centric Loyalty System”, filed on Mar. 27, 2003, which is incorporated by reference in its entirety for all purposes.

### BACKGROUND OF THE INVENTION

The present invention generally relates to loyalty transactions and more specifically to a system and method for providing an instant win program using a portable device and base device.

Loyalty programs are programs that provide customers with incentives to shop at certain merchants participating in the loyalty programs. Typically, customers are awarded incentives under a loyalty program when they shop at the merchants participating in that loyalty program. The incentives may then be redeemed at a later time.

Instant win programs, such as sweepstakes or lottery programs, are programs that award prizes if the instant win program is won. Typically, instant win programs are provided using a paper-based delivery system (e.g., scratch and win for lottery tickets) or a back-office based drawing system. These systems have many inefficiencies. For example, the cost of operations for running the systems is relatively high and the flexibility of distributing the prizes for the systems is limited. For instance, instant winners at the point of delivery are only practical for small amounts with scratch and win tickets. Additionally, it is difficult to link wins in instant win programs to certain behavior that is attractive to a loyalty program sponsor. Accordingly, the power of leveraging a loyalty and instant win program together is lost even though these programs are the most powerful tools available to promotions managers.

Thus, it is desirable to provide an improved instant win program in addition to providing a loyalty program in conjunction with an instant win program.

### BRIEF SUMMARY OF THE INVENTION

Embodiments of the present invention generally relate to providing an instant win program at a base device during a transaction between the base device and a portable device and also to providing a loyalty program in conjunction with an instant win program.

In one embodiment, a method for providing an instant win program during a transaction between a base device and a portable device is provided. The method comprises: establishing a connection between the portable device and the base device to initiate the transaction between the portable device and base device; determining information for the instant win program at the base device; and using the information to determine if the portable device is eligible for a prize in the instant win program during the transaction.

In another embodiment, a method for providing a loyalty program in conjunction with an instant win program is provided. The method comprises: processing a loyalty transaction associated with the loyalty program for a portable device; determining if the portable device is eligible for the instant win program based on at least information associated with the loyalty transaction; and if eligible for the instant win program, determining, for the portable device, a result of the instant win program based on at least the determined information during the loyalty transaction.

Reference to the remaining portions of the specification, including the drawings and claims, will realize other features and advantages of the present invention. Further features and advantages of the present invention, as well as the structure and operation of various embodiments of the present invention, are described in detail below with respect to accompanying drawings, like reference numbers indicate identical or functionally similar elements.

### BRIEF DESCRIPTION OF THE DRAWINGS

FIG. 1 depicts a simplified block diagram of an exemplary embodiment of a loyalty system that includes a portable device, a base device, an administrative host, and an interface in accordance with the present invention;

FIG. 2 illustrates a more detailed block diagram of the system according to one embodiment;

FIG. 3 illustrates a flow chart of a method for providing an instant win program according to one embodiment of the present invention;

FIG. 4 depicts a flowchart of a method for distributing a prize for an instant win program according to one embodiment of the present invention; and

FIG. 5 illustrates an embodiment of the administrative host in accordance with the present invention.

### DETAILED DESCRIPTION OF THE INVENTION

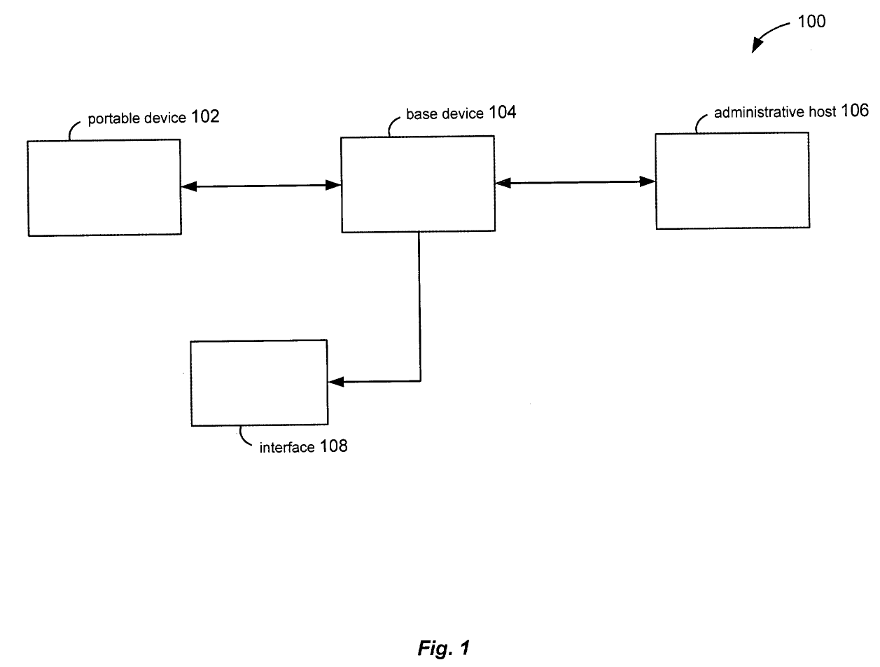

FIG. 1 depicts a simplified block diagram of a loyalty system 100 that includes a portable device 102, a base device 104, an administrative host 106, and an interface 108 according to an exemplary embodiment of the present invention. Devices in loyalty system 100 may communicate through any means, such as a wireline network, wireless network, infrared connection, the Internet, etc. In an exemplary embodiment, system 100 may be part of a system described in U.S. patent application No. ______, entitled “Network Centric Loyalty System”, filed on Mar. 27, 2003, which is incorporated by reference in its entirety for all purposes. Although one portable device 102, base device 106, and host 106 are shown, it should be understood that any number of portable devices 102, base devices 104, and hosts 106 may be included in system 100.

Portable device 102 is used to communicate with base device 104. In one embodiment, portable device 102 may include a smartcards, cellular phones, personal digital assistants (PDAs), pagers, payment cards, security cards, access cards, smart media, transponders, or any other device that can communicate with base device 104. Portable device 102 may be a personal device, which may have computing ability, that is typically held by a consumer or individual. Portable device 102 includes a set of unique characteristics that, in an exemplary embodiment, includes local and secure storage of a unique identifier. The unique identifier may be used to uniquely identify the consumer or individual that holds portable device 102. Although the unique identifier may identify the portable device holder (hereinafter “holder”), which is the holder of portable device 102 at the time of the transaction or at the time of communication with base device 104, the unique identifier may identify a consumer or individual other than the portable device holder. For example, the unique identifier may identify a user that is in possession of portable device 102 and uses it.

Portable device 102 is issued by a portable device issuer. A portable device issuer is the owner and/or provider of portable device 102 and also may provide the unique identifier that is stored on portable device 102. In other embodiments, entities other than the portable device issuer may provide the unique identifier, such as host 106. In one example, a portable device issuer is a financial institution such as a Visa Member institution.

Base device 104 is a computing device that is capable of communicating with portable device 102. Base device 104 facilitates the performance of a loyalty transaction and/or instant win program transaction with portable device 102 in a substantially off-line or standalone manner. Base device 104 is owned and operated, preferably separately, from portable device 102. Examples of base devices 104 include point of sale (POS) devices, cellular phones, PDAs, personal computers (PCs), tablet PCs, handheld specialized readers, set-top boxes, electronic cash registers (ECRs), virtual cash registers (VCRsj, kiosks, security systems, access systems, automated teller machines (ATMs), or any other device that can communicate with portable device 102. A base device operator (hereinafter “acceptor”) is an entity or person responsible for the operations of base device 104 and optionally the owner of base device 104. For example, a base device operator may be a clerk of a store that is the owner of base device 104.

Base device 104 includes an interface 108 that is used to communicate with the portable device holder. Interface 108 may be part of base device 104, be duplicated in portable device 102, and/or shared with portable device 102. Base device 104 and/or portable device 102 may also include some or all of the operations of interface 108. Some operations of interface 108 include displaying, printing, or sounding messages to the portable device holder and/or the base device operator.

Base device 104 is also capable of communicating in a substantially real-time basis with administrative host 106. In an exemplary embodiment, administrative host 106 is remotely located from base device 104. Administrative host 106 includes a computing device that is capable of communicating with base device 104 to collect data about transactions and also to provide programming data for the instant win program transactions and computations of rewards and/or prizes for the transactions. The programming data for an instant win program includes rules and regulations governing the operations of the instant win program and/or the loyalty program. The programming data can be modified from time to time and uploaded to the appropriate base devices 104. Administrative host 106 is capable of managing one or more loyalty programs and/or instant win programs and a plurality of base devices 104 and portable devices 102. Base device 104 and administrative host 106 may be two separate components or physically combined.

In one exemplary illustration, loyalty and instant win transactions are performed between portable device 102 and base device 104 in cooperation with each other in a substantially off-line or stand-alone manner without interaction with administrative host 106. For example, base device 104 may include storage and logic to determine if portable device 102 is eligible for a prize in an instant win program. This may be done in a substantially offline or offline manner. It may be required that base device 104 contact administrative host 106 in some cases. For example, base device 104 may contact host 106 to validate that portable device 102 should be awarded the determined prize. In this case, however, base device 104 may have determined that portable device 102 is eligible for a prize without contacting host 106. In an alternative illustration, administrative host 106 may participate in the execution of the loyalty and instant win transaction.

Portable device 102 and base device 104 participate in transactions. A transaction may be when portable device 102 is participating in a loyalty transaction with base device 104. The transaction, however, may be just a communication between portable device 102 and base device 104 without the requirement of performing a loyalty transaction. For instance, base device 104 may be used by the portable device holder to query base device 104 for past instant win results. When a transaction is initiated between portable device 102 and base device 104, portable device 102 may be eligible for an instant win program. In one embodiment, an instant win program is any program that involves a chance to win the program. For example, a lottery is an instant win program for an earning of an award that is independent of any other activity that might involve the holder and the acceptor. A sweepstakes is an instant win program for an earning of a reward related to a promotional activity targeting the holder or the acceptor. In an exemplary embodiment, the eligibility of portable device 102 to participate in an instant win program is logically determined at the time of the transaction by base device 104. In an exemplary embodiment, when a portable device 102 is eligible for an instant win program, it is determined at the time of the transaction if portable device 102 wins the instant win program. In other embodiments, whether portable device 102 has won the instant win program may be delayed until another time.

An awards/rewards sponsor (hereinafter “sponsor”) is a provider of prizes and incentives and also defines the terms and conditions for participation in the instant win program. The sponsor may also define the terms or conditions required for base device 104 to distribute a prize and whether base device 104 should validate with host 106 the distribution of such prize. Also, the sponsor may define whether base device 104 should record data on all or part of a transaction. The data may be stored locally for future communication to host 106 or be transmitted in a substantially real-time basis to host 106. Other information the sponsor may define is information pertaining to the frequency of instant win programs, distribution of prizes, conditions for distribution, geographic allocation of prizes, or any other parameters relevant to the execution of the instant win program. The administration of the instant win program may be remotely performed by administrative host 106. Administrative host 106 ensures the appropriate availability of services to all base devices 104 that are participating in the instant win program.

A scheme provider provides the necessary services that allow portable device 102 and base device 104 to conduct a transaction. For example, the scheme provider provides the logic necessary to provide the instant win program according to the parameters defined by the sponsor. The logic may be provided to host 106, which downloads the required information necessary to provide the instant win program to base device 104. The services provided by the scheme provider may include the operation of the administration host 106, the determination of business and technical rules governing the use of the system, and the delivery of the services required to allow the execution of an instant win and/or loyalty program. Although the acceptor, issuer, scheme provider, and sponsor are described as different entities, it will be understood that they may be the same entity, separate entity, or any combination thereof. Each may engage in one or more functions required to use and implement the loyalty and instant win programs.

The loyalty programs and instant win programs provide incentives. For example, incentives include an award, which is an item that is awarded independently of any action, and an incentive, which is related to promotional activity and given as an incentive to perform a certain action. Thus, an incentive may be given for a loyalty transaction and a chance to win an award in an instant win program may be given for the same loyalty transaction. Also the value of a loyalty incentive may be determined in combination with the instant win program and may be determined using information from a transaction for the instant win program.

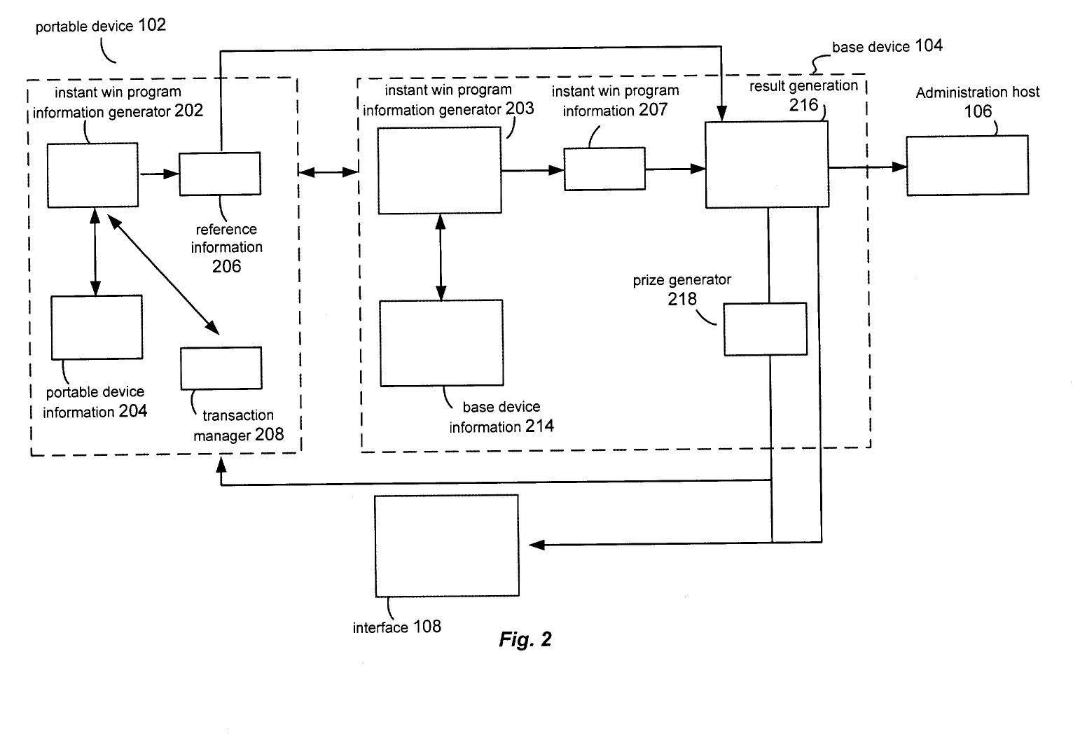

FIG. 2 illustrates a more detailed block diagram of system 100 according to one embodiment. During a transaction, portable device 102 communicates with base device 104.

Portable device 102 includes an instant win program information generator 202, portable device information 204, instant win program information 206, and a transaction manager 208.

During a transaction, a holder presents portable device 102 to base device 104. Upon establishing a connection between portable device 102 and base device 104, transaction manager 208 may determine whether portable device 102 is eligible for a loyalty transaction and/or an instant win program transaction. Additionally, transaction manager 208 may interact with base device 104 to determine if portable device 102 is eligible for participation in one or more instant win programs. In determining the eligibility, information from a loyalty transaction, payment transaction, or other transaction requiring the use of the portable device 102, may be used. In one embodiment, eligibility for the instant win program may be contingent on it being earned from the loyalty program. For example, after a certain number of loyalty transactions, portable device 102 may be eligible for the instant win program. In other embodiments, the eligibility may be inherent or automatic. Also, information from the transaction, portable device 102, base device 104, or any other information may be used to determine the eligibility. For example, certain portable devices 102 may be eligible for an instant win program after a certain number of loyalty transactions have been performed. Also, certain portable devices 102 may be eligible for the instant win program and will be eligible when a transaction with base device 104 is initiated. If portable device 102 is eligible for an instant win program, transaction manager 208 communicates with instant win program information generator 202. It should be understood that although transaction manager 208 is described as being part of portable device 102, it can be part of base device 104 or any combination of its functions may be distributed between portable device 102 and base device 104.

Instant win program information generator 202 is configured to determine reference information that will be used to determine if a prize will be awarded to portable device 102 for the instant win program. It should be noted that reference information 206 may be determined either from instant win program information generator 202 found in portable device 102, instant win program information generator 203 found in base device 104, or by a combination of actions by both instant win program information generators 202 and 203. In an exemplary embodiment, instant win program information generator 202 uses an instant win algorithm that may include a computation that is performed to determine reference information 206. In one example, the instant win algorithm uses portable device information 204 to determine reference information 206. In one embodiment, reference information 206 and/or portable device information 204 may be stored in storage in portable device 102. The storage may be secure to protect reference information 206 and/or portable device information 204 from unwanted use. Thus, reference information 206 may be a constant that is used for all transactions or generated anew for all or some transactions. Portable device information 204 is any information that is associated with portable device 102 or any information regarding a transaction, such as a loyalty transaction, payment transaction, or other transaction requiring the use of portable device 102, being performed between portable device 102 and base device 104. For example, portable device information 204 may include unique information for the holder of portable device 102, an account number, and a computer chip serial number found in portable device 102, etc. In another embodiment, instant win program information generator 202 may generate a random number for reference information 206. In yet another embodiment, base device information 214 or any combination of the above information may be used to generate reference information 206. Based on the disclosure and teachings provided herein, a person of ordinary skill in the art will appreciate other ways and/or methods to generate reference information 206.

Instant win program information generator 203 also determines instant win program information 207. It should be noted that instant win program information 207 may be determined either from instant win program information generator 202 found in portable device 102, instant win program information generator 203 found in base device 104, or by a combination of actions by both instant win program information generators 202 and 203. In one embodiment, information 207 is determined using base device information 214. Base device information 214 may be any information from base device 104 or any information regarding a transaction, such as a loyalty transaction, payment transaction, or other transaction requiring the use of portable device 102, being performed between portable device 102 and base device 104. For example, base device information 214 may include a time stamp or time indicator of the transaction, for instance, a time interval during the day, which may be generated by base device 104 during the transaction, or for instance, the sequential value of a transaction counter, or a local constant, such as the base device identification or a unique identifier for the transaction, such as a transaction identifier of a payment transaction that was carried out before the instant win program transaction or the case where a purchase is performed, the price of the purchase. Base device information 214 may also include a determined random number. Other information that may be used by information generator 202 may include a constant that has been generated remotely by administrative host 106 and communicated to base device 104. For example, a number, as in a raffle, determined remotely and securely stored in base device 104 may be used. In other embodiments, portable device information 204 or any combination of the above information may be used to generate instant win program information 207. In one embodiment, instant win program information 207 and base device information 214 may be stored in storage in base device 104. The storage may be secure to protect instant win program information 207 and/or base device information 214 from unwanted use. Thus, instant win program information 207 and/or base device information 214 may be a constant that is used for all transactions or generated anew for all or some transactions. Similarly, based on the disclosure and teachings provided herein, a person of ordinary skill in the art will appreciate other ways and/or methods to generate instant win program information 207.

Once reference information 206 and instant win program information 207 are determined, instant win program information 207 and reference information 206 are communicated to a result generator 216.

In one embodiment, reference information 206 includes a reference parameter and instant win program information 207 includes an instant win variable. Both the reference parameter and instant win variable are generated by any combination of instant win program information generator 202 and instant win program information generator 203. The reference parameter may be constant from transaction to transaction or recomputed for every transaction as a function of the instant win program parameters that are defined by the sponsor and/or the scheme provider. The instant win variable may be constant or computed using information from the transaction. However, both the reference parameter and instant win variable may be computed using any of the above information that was described above.

Result generator 216 uses reference information 206 and instant win program information 207 to determine if portable device 102 wins the prize associated with the instant win program. In one embodiment, result generator 216 may compare the reference parameter and instant win variable and if they match, determine that portable device 102 has won the instant win program. Result generator 216 may also use any other methods to determine if the information received is eligible for the prize of the instant win program. If result generator 216 determines that portable device 102 is not eligible for a prize in the instant win program, a message is sent to interface 108 that indicates as such. For example, an apology message may be sent to interface 108 for the holder and also may include discretionary/promotion information for the sponsor. Additionally, messages could also include a thank-you note for participating, for purchasing certain goods and services, or for encouraging subsequent visits. Information for the result may also be communicated to portable device 102.

If it is determined that portable device 102 is eligible for a prize, result generator 216 communicates with prize generator 218. Prize generator 218 then determines the prize that should be provided to portable device 102. In an exemplary embodiment, prize generator 218 may use an incentive algorithm that determines the value of the prize. The value of the prize may use any of the above mentioned data, such as portable device information 204, base device information 214, or transaction information. Also, a pre-set constant, defined remotely by the sponsor and communicated to base device 104 by administrative host 106 may be used. For example, the pre-set constant may be a pre-defined prize. A characteristic of base device 104 may also be used, such as the base device ID, location, or type such as physical or online, to determine the prize. A characteristic of portable device 102 may also be used, such as unique data for portable device 102 that is stored in portable device 102, possibly including information about previous participation, membership into a targeted class of holders, such as gold customers, etc. A local random draw among a range of values for the rewards, such as a range value either being a discrete set of options (e.g., prizes 1, 2, or 3) or continuous set value (e.g., a dollar value from X to Y) may also be used. Further, selection by the portable device holder may be used with a discreet or continuous set of prizes. For example, the holder of portable device 102 may be asked to pick a prize from a list. Additionally, control parameters defined remotely by the sponsor, such as the maximum number of wins by a single holder or single portable device 102 may be used in addition to a maximum number of wins at a single base device 104, a maximum number of wins in the overall instant win program, or regulatory compliance parameters such as a specific portable device 102 may be eligible to win only once. In addition to the above possibilities, any other information and methods may be used to generate the prize given to portable device 102 by prize generator 218.

Once prize generator 218 determines the award that portable device 102 is eligible for, it communicates the prize to interface 108. A message is then generated by interface 108 that indicates to the holder of portable device 102 that he/she is eligible for a prize. The message may also include the conditions of distribution of the prize or optionally, discretionary/promotional information from the sponsor. Interface 108 may be used to allow the portable device holder to perform certain activities required to receive the prize, as set forth in the conditions of distribution, such as positively accepting the prize or answering a survey.

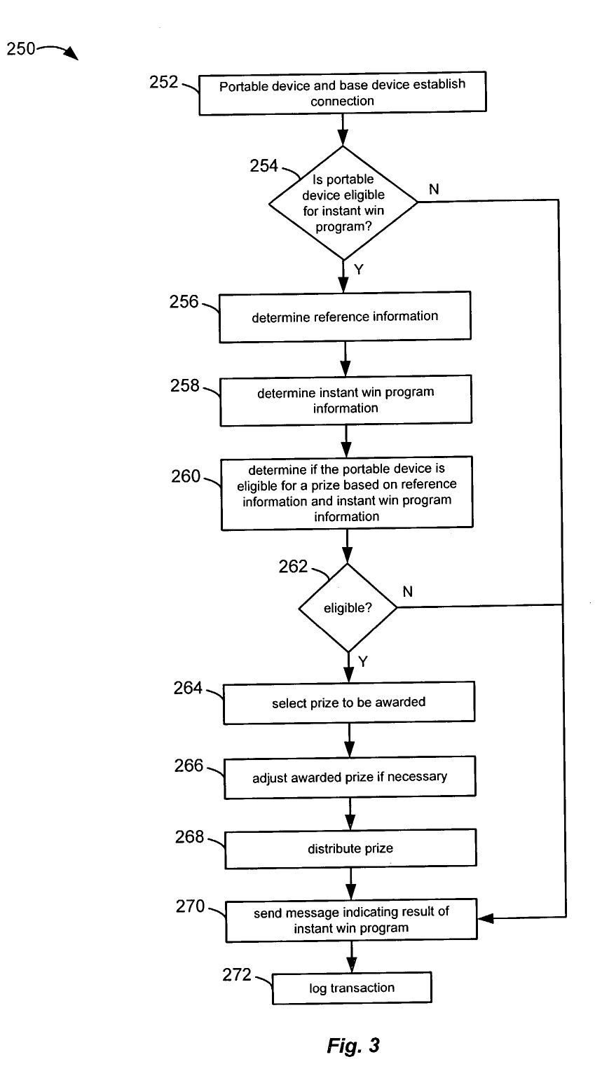

FIG. 3 illustrates a flow chart 250 of a method for providing an instant win program according to one embodiment of the present invention. In one exemplary illustration, the method is performed between portable device 102 and base device 104 in cooperation with each other in an off-line or stand-alone manner without interaction with administrative host 106. In an alternative illustration, administrative host 106 may participate in the execution of the method, for example, to validate the eligibility of portable device 102, the instant win selection, the prize earned, and the distribution method. In step 252, portable device 102 and base device 104 establish a connection. The connection may be through any means, such as a wireless, infrared, wireline connection, etc.

In step 254, it is determined if portable device 102 is eligible for an instant win program. The determination may be made using any information, such as portable device information 204, base device information 214, transaction information, loyalty transaction information, or any combination thereof. Also, the determination may be made using logic found in portable device 102, base device 104, administrative host 106, or any combination thereof. If portable device 102 is not eligible for the instant win program, the process proceeds to step 270, where a message indicating that portable device 102 is not eligible for the instant win program is communicated to the holder of portable device 102.

If portable device 102 is eligible for the instant win program, reference information is determined in step 256 and the instant win program information is determined in step 258. It should be noted that step 256 and step 258 may be interchangeable or they may be performed concurrently. In an exemplary embodiment, reference information may include reference information 206 and instant win program information may include instant win program information 207; however, reference information and instant win program information may include any combination of information accessible or generated by portable device 102 and/or base device 104.

In step 260, it is determined if portable device 102 is eligible for a prize based on the reference information and instant win program information. In an exemplary embodiment, the reference information is compared to the instant win program information and if they match, it is determined that portable device 102 is eligible for a prize. In addition to comparing the reference information and instant win program information, it should be noted that other methods may be used to determine if portable device 102 is eligible for a prize.

In step 262, if portable device 102 is not eligible, the process proceeds to step 270, where a message indicating that portable device 102 is not eligible for the instant win program is communicated to a holder of portable device 102.

If portable device 102 is eligible for the instant win program, in step 264, a prize to be awarded is selected. The selection of the prize may be contingent on the reference information, instant win program information, the transaction information, portable device information 204, base device information 214, or any other factors, such as a preset constant or a random draw among a set option or range of incentives.

In step 266, the prize awarded is adjusted if necessary. For example, parameters or restrictions may be imposed on portable device 102 or a holder of portable device 102, such as a maximum number of wins per holder, portable device 102, or base device 104, a maximum number of wins system-wide, local regulatory compliance parameters, or other restrictions or parameters.

In step 268, the prize is distributed. There are many methods of distribution, some of which are described below.

In step 270, a message is sent indicating the result of the instant win program; in this case, a message indicating the prizes awarded in the instant win program is communicated to the holder. Other information may also be communicated to the user, such as promotional information, in terms of distribution of the prize, or terms and conditions related to the instant win program. In the case where user action is required for the distribution of the prize, such as positive acceptance of the prize, a further message directing the action is provided, and the action is undertaken.

In step 272, a transaction is logged. For example, the transaction may be logged in portable device 102, base device 104, or combination of portable device 102 and base device 104, or base device 104 may communicate the transaction log to administrative host 106. The storing of information in portable device 102 or base device 104 may be done using a protected and/or tamper proof method. The stored information may later be used for customer service purposes. For example, a holder of portable device 102 may contact customer service and a representative may use the stored information to provide customer service for the holder of portable device 102.

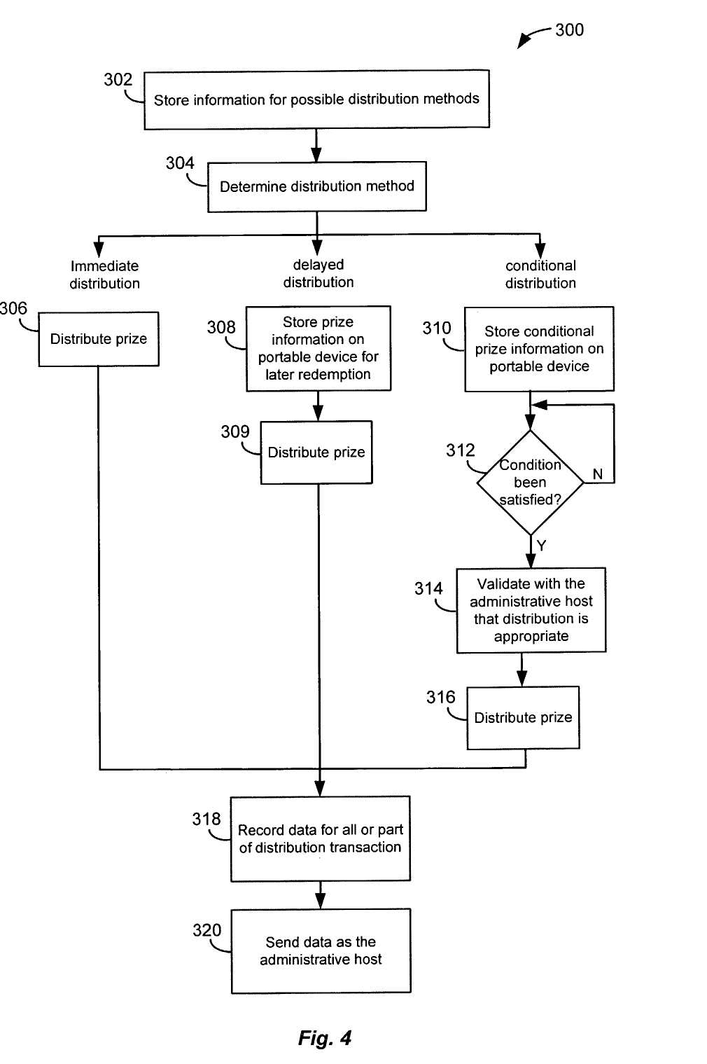

After it is determined that portable device 102 is eligible for a prize for one of the instant win programs, the prize may be distributed to portable device 102 or the holder of portable device 102 in a number of ways. FIG. 4 depicts a flowchart 300 of a method for distributing a prize for an instant win program according to one embodiment of the present invention. In step 302, information for possible prize distribution methods is stored in base device 104. In an exemplary embodiment, the distribution methods are set up by a scheme provider or program sponsor for the instant win program at administrative host 106. As mentioned above, the sponsor may define parameters that will be used to define the instant win program. The scheme provider can then define logic that will implement the instant win program using the parameters at host 106. Administrative host 106 then downloads the possible distribution methods to base device 104.

Once it is determined that portable device 102 is eligible for a prize, in step 304, base device 104 determines the appropriate distribution method for the prize. For example, possible distribution methods may be an immediate distribution, delayed distribution, or conditional distribution. Immediate distribution takes place at the time and location of the transaction. For delayed distribution, prize information is stored on portable device 102 for later redemption. Information storage may be done using a method ensuring the protection of the information and the detection of any tampering attempts. Conditional distribution requires the holder of portable device 102 to perform a prerequisite activity in order to receive the prize. Such activity may include the positive acceptance of the prize by the portable device holder, which may be used to comply with local regulations, such as tax regulations. As mentioned above, the sponsor may define parameters that define the terms and conditions for distributing prize in the instant win program. These parameters are then implemented by the scheme provider at host 106, which then downloads the necessary logic to base devices 104.

In step 306, if immediate distribution is determined, the prize is distributed at the time and location of the transaction.

In step 308, if delayed distribution is determined, prize information is stored on portable device 102 for later redemption. Information storage may be done using a method ensuring the protection of the information and the detection of any tampering attempt. In this case, in step 309, at a later time, when the holder of portable device 102 desires redemption, a transaction is initiated, redemption is chosen, and the prize is distributed. The prize may be distributed at that time. For example, a user may be required to go to a prize distribution area where prizes are designated to be distributed.

If conditional distribution is determined, in step 310, conditional prize information is stored on portable device 102. Information storage may be done using a method ensuring the protection of the information and the detection of any tampering attempts. The conditional prize information requires that the holder of portable device 102 perform a requisite activity in order to receive the prize.

In step 312, when a transaction is performed, it is determined if the condition has been satisfied. If the condition has been satisfied, in step 314, base device 104 may validate with administrative host 106 that distribution is appropriate. This validation may be performed in a substantially real-time basis and may be used to verify that the distribution of the prize is valid or that the action taken was a correct action. The validation ensures the reliability of the distribution of the prize. For example, validation may be used in the case where very high value prizes are to be distributed.

In step 316, the prizes are distributed to the holder of portable device 102.

In step 318, whether the distribution was immediate, delayed, or conditional, when the prizes are distributed, base device 104 may store data for all or part of the distribution transaction. Additionally, transaction data may be stored whether or not portable device 102 was determined to have won the instant win program or whether a prize was distributed immediately or stored in portable device 102 for delayed distribution.

In step 320, the stored data for all or part of the distribution transaction may be sent to administrative host 106 and/or portable device 102.

In other embodiments, in the case of delayed or conditional distribution or when controlled parameters for an instant win program impose the limits for the number of wins allowed for a portable device 102 or holder of a portable device 102, information about the transaction, the prize, and/or the distribution method of the prize is stored on portable device 102. The data that are stored may then be protected from tampering using methods known in the art, which may include Message Authentication Coding (MACing), digital signatures, other electronic validation methods, or the like. Also, when prize information or conditional prize information is stored in portable device 102, base device 104 may also provide programming parameters for the distribution, such as terms and conditions for the instant win program or a holder's selection of the prize for the instant win program. This information may then be used when the prizes are distributed.

Also, limits on earned prizes may be given a validity period. Base device 104 or administrative host 106 may clear the eligibility for the prize and/or the information relevant to the prize stored on portable device 102 when the validity period is over.

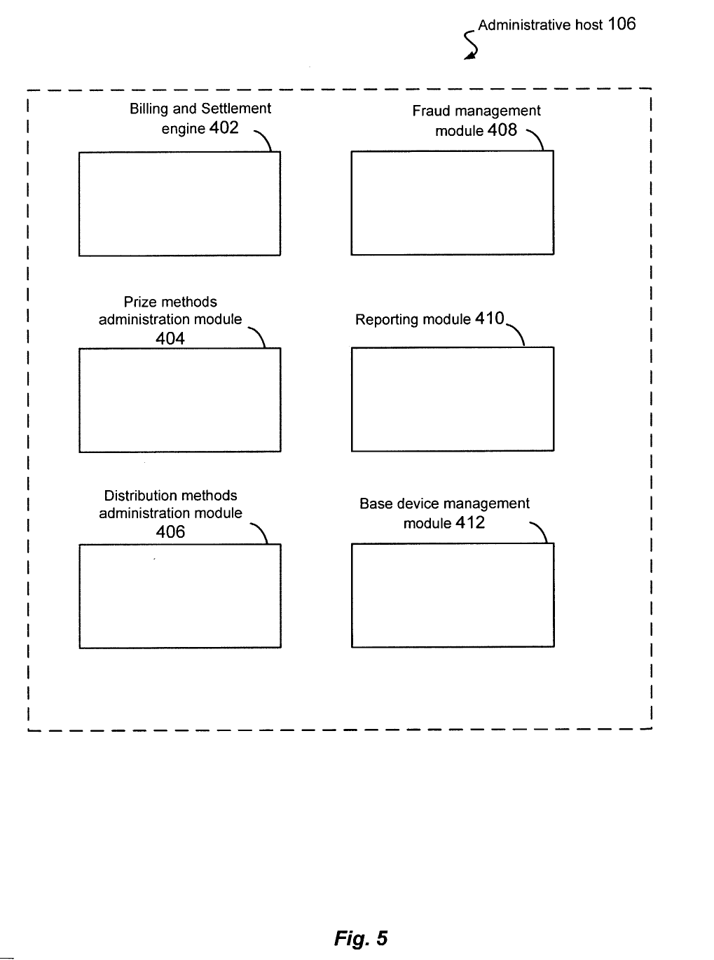

FIG. 5 illustrates an embodiment of administrative host 106. Administrative host 106 communicates with base device 104 to administer the instant win programs. Administrative host 106 downloads data related to instant win program transactions and also uploads data related to new or existing instant win programs to base device 104. For example, some data that may be communicated are prize participation eligibility and validity dates for distribution of prizes; terms and conditions for participation in the instant win programs, instant win methods and data to perform the instant win program; incentive methods and data necessary to perform the incentive methods; storing protection methods for prize information, and data necessary to perform the storing of prize information protection methods; prize distribution methods and data necessary to perform the prize distribution methods; security algorithms; data keys that may be used to secure delayed distribution of prizes; and base device administrative data including unique identifiers for the base devices 104.

Through administrative host 106, a scheme provider is able to accomplish at least the following functions: billing and settlement of prizes; administration of instant win algorithms and incentive algorithms with their associated data; remote management and support of installed base devices 104; fraud detection and control routines; and reporting. In an exemplary embodiment, the above functions are accomplished by billing and settlement engine 402, instant win/incentive methods administration module 404, distribution methods administration module 406, fraud management module 408, reporting module 410 and base device management module 412.

Billing and settlement engine 402 provides the billing and settlement for transactions performed by base device 104. For example, in the case where the instant win program sponsor is different from the acceptor and/or the issuer, monetary settlement for a prize distributed by the acceptor or billing for certain services rendered, such as promotion or customer service at a help desk, may be required. Billing and settlement engine 402, by analysis of the transaction logs communicated by base devices 104, is able to perform billing and settlement functions electronically by billing directly the various parties that are involved in the transaction. Also, billing and settlement engine 402 may directly transfer funds between the parties affected by the transaction.

Administration of the instant win programs and corresponding prizes and incentives may be managed by prize methods administration module 404 and distribution methods administration module 406. Prize methods administration module 404 is configured to manage the instant win parameters and incentive parameters. Distribution methods and administration module 406 is configured to apply the distribution methods, for example, the method as described in FIG. 4. Sponsors will provide information to the scheme provider pertaining to, for example, the frequency of games, distribution of prizes, conditions for distribution, geographic allocation of prizes, or any other parameters relevant to the execution of an instant win program. Administration modules 404 and 406 ensure that these parameters are correctly programmed into the instant win program, prize and distribution methods, and distributed in a fashion which may be specifically secured to the individual, appropriate base devices 104.

Fraud management module 408 is used to manage the instant win programs to limit fraud. Fraud management module 408 analyzes data provided by base devices 104. For instance, by comparing actual logs of instant win prizes and distribution of prizes with theoretical projections for the chosen methods, module 408 can determine whether fraud may be occurring in the system. In one example, the audit of distribution for delayed or conditional prizes is important because consumers may manipulate information in a portable device 102 and attempt to obtain a delayed or conditional prize. If a fraud is detected, administrative host 106 may alert the scheme provider for cancellation of a program, reset security prompt parameters such as encryption keys, download a specific portable device identifier to base devices 104 that indicates that prize distribution should be refused for any portable device 102 with that specific portable device identifier, invalidate the eligibility of a portable device 102 or a device holder to participate in programs, block a base device 104 from participating in a program, or take any other appropriate actions. These actions may be performed by fraud management module 408 in substantially real-time once the fraud is detected. Thus, fraud management module 408 may automatically detect fraud and perform an action based on the detected fraud.

Reporting module 410 is used to report information about the instant win programs to program sponsors, acceptors, and issuers. The parties may then use the information for management of a program, for example, for understanding the program performance. Information that may be reported by reporting module 410 includes data required to perform customer service and assistance, tax reporting of winnings, or dispute resolutions. Reporting module 410 may also provide various parties involved in each program with separate data that is available in the instant win program. The distribution of data may be performed in compliance with required privacy policies set by the scheme provider or other laws applicable to programs in question. Also, in the case of a loss or destruction of a portable device 102 on which a prize was stored for delayed or conditional distribution, administrative host 106 on the request of a sponsor or scheme provider, may recreate the prize information either for immediate distribution or for storage in a particular portable device 102. Thus, the records of administrative host 106 were used to verify that portable device 102 is eligible for the prize and download information to portable device 102 to allow redemption of the prize.

Base device management module 412 is used to communicate with base devices 104 and manage base devices 104. Management of base devices 104 may include the registration of base devices 104, the determination of a unique identifier or a group of individual identifiers for base devices 104, tracking of the states of base devices 104, in particular, the state as it pertains to data collection specific to each base device 104, notification of servicing of base device 104 by the acceptor or its agent, and protecting the distribution of keys and data used in securing prizes and transactions, and communication with a plurality of base devices 104. Additionally, base device management module 412 may communicate any other information necessary to implement an instant win program and/or a loyalty program.

Examples for determining instant win program winners will now be described. In one example, a transaction parameter and a preset and/or algorithmically generated number may be matched to determine an instant win program winner, such as if the last six out of nine digits of a transaction identifier matched a pre-selected number, the user of the portable device will win the instant win program. An example is if the last six digits for a transaction identifier “1 2 3 4 5 6 7 8 9” match the pre-selected “4, 5, 6, 7, 8, 9.” Another example for determining instant win winners is by matching a time stamp of the transaction or the price of the purchase to a preset time stamp or a preset price.

Another method that may be used to determine an instant win program winner may be matching two computed parameters. For example, the last four digits of a transaction identifier may be matched with the minutes and seconds of a time stamp. Also, a match of a limited hash (such as folding parameters by an exclusive OR of every other digit) of a portable device ID with a limited hash of a base device ID may be used.

Examples for determining prizes will now be described. In one example, an offer of a choice of prizes for the holder of a portable device 102 or base device operator will be provided where the holder or base device operator may pick amongst the choices. A value in a range (e.g., an instant discount coupon between 5% and 75%) may be picked for a particular distribution. A prize in a predefined set of prizes (one free ticket, one upgrade, or 20,000 miles, or one upgrade in a one-month trial test at a traveler's lounge) may also be randomly picked as a prize. A prize may be provided according to overall transaction parameters such as, for example, get a free pack of Coca Cola for buying specific items used to barbecue; receive $20 worth of baby food for purchasing diapers; or receive 50% off the purchase of a cosmetic item for purchasing a specific brand of fragrance. A prize may also be provided according to the customer status, such as $5 off of total purchase amount for a first time client and $15 off the total purchase amount for clients who have visited a store three times this month.

Examples of distribution methods will now be described. For an instant win distribution method, a prize is given at the time of the transaction. For a prize that may be claimed on a subsequent visit, a deep discount coupon may be distributed and redeemed at a future visit. Also, in a conditional win, extra activity is required, such as answering a survey, visiting a particular website or physical location, calling a promotional hotline, or positively accepting the prize.

Examples of the instant win programs will now be described. The creation of an instant win program using a smart card may be provided. Rather than waiting for an instant win notification to occur in a remote delayed fashion, instant winners may be created when users use their smart card. Instant wins can be for large or small prizes and in all cases they create more consumer satisfaction. Additionally, the smart card holder whose card is used for the purchase and a merchant clerk who performs the purchase transaction could both be instant winners. Thus, the merchant clerk is given an incentive to encourage the user to use their smart card and also to participate in the smart loyalty instant win or other smart rewards and smart loyalty programs.

Another example includes a combination of an instant win program with a loyalty program to produce from time to time, exceptional discounts for patronage. This may generate renewed interest for a loyalty program. Some examples of this combination include: a mystery discount program; a large grand prize (e.g., receive one point for every purchase and also be entered for a million points award); combining a product level loyalty program with a product level sweepstake such as “buy a packaged meal and possibly win it supersized”; and programs where a large number of cardholders become eligible for random draws of a variety of small prizes (a thousand cardholders are selected to win $10 every day). Thus, the idea of less predictability of awards (as in $1 equals one point), but more likely awards than for a single large prize instant win (win a million points) may be offered. Also, in cases where a holder does not reach a threshold for accrual of a benefit under a loyalty program, the holder may be entered into an instant win program for random prizes. Additional performance-based instant win programs may include any cardholders who achieve certain thresholds are entered into “thank you” instant win programs rather than simply receiving predictable higher level discounts. Also, for performance-based instant win programs, merchant clerks at a store location or groups of stores who achieved certain sales thresholds within a certain timeframe could be entered into the instant win programs.

Another example of an instant win program is a layered instant win program. A layered instant win program counts transactions and facilitates multilayered games of chance, such as “use your card 1-3 times this month and you could win X; use your card 4-10 times and you could also win Y; use your card 11+ times and you could also win Z.” A related application is a multilayered instant win program where different merchants are involved. For example, a program that promotes using your smart check card for a one-movie ticket purchase (any theater merchant) and you could win X; use it for two movie purchases (could be two different movie theater merchants), you could also win Y; and use it three times at the movies and you could also win Z. The above scheme may be used to encourage the use of smart check cards at theaters.

A further example is when the instant win program incentive methods are tied to the use of a system. For example, the associated issuer and portable device may be a smart payment card and its financial issuer, but also may be a phone and an associated telecom operator, and the instant win program may be predicated on the use of the phone and if the user uses an X amount of airtime, the chances of winning the instant win program are increased.

A joint promotion may also be implemented. In this promotion, a unique use of a combination of the instant win program system with another platform could be a joint merchant promotion in an instant win program for promoting debit card usage at a fast food chain at a specific movie theater. Thus, using a card for purchases at both types of participating merchants triggers an entry into an instant win program. Prize amounts and types could be higher for holders that purchase at both the fast food chain and participating movie theater within a specified timeframe.

Embodiments of the present invention provide many benefits. For example, for the issuer, the instant win program increases the perceived value of the portable device and services it provides. Also, because the prize sponsors may be potentially different, the costs for providing programs for different sponsors are reduced because of the central administrative host system. For the acceptor, the system allows for the automation of the instant win process. For the prize sponsor, the system may be combined with a variety of other transactions thus creating unique marketing opportunities. Also, the cost may be lowered by the automation of the process. Also, because the sponsors aren't necessarily the acceptor, the ability of both to increase the reach of their program is significantly increased as the network of the acceptor increases.

Other benefits of the automation of the process include when using the fraud management, tracking the eligibility of the program allows the ability for sponsors to limit their financial exposure. Also, the support of dual computation of instant wins (i.e., the generation of the reference parameter and instant win variable) reduces the chances of fraud such as replay or counterfeiting of portable devices that include unearned redemptions. Also, the storage of prize information in a protected and tamper proof way reduces the risks of counterfeit fraud.

The support at the base device for selection or random determination of a prize with incentive methods allows for advanced marketing or promotional strategies to be implemented. Also, the support for multiple distribution strategy further enhances the marketing relationship with a customer and may entice a customer to perform additional transactions as with a conditional distribution.

The use of an administration infrastructure, such as administrative host 106, reduces operating costs for using an instant win program and/or a loyalty program. The cost of administering the instant win program is also reduced due to the elimination of the need for management of database entries and the random implementation of prize selection. Additionally, the automation of performing the instant win program reduces costs because no manual selection of winners is required and also no database management of eligible entries for each instant win program is needed. Thus, multiple parallel and concurrent instant win programs may be implemented without increasing the manpower required to administer the programs. Also, in addition to the costs being reduced, the implementation for an instant win program and deployment of it is shortened because the deployment is electronic.

For cardholders, the delivery method and communication of instant win program prize descriptions, rules, etc. is simpler because they can be downloaded from administrative host 106 to base device 104 and provided to a holder of a portable device 102, using interface 108.

The instant win programs are simplified for including multiple sponsors because sponsors can leverage each other's instant win programs to incite some usage behavior. For example, a card issuer and a merchant may offer an instant win program where each win is sponsored by a card issuer when the cardholder visits a specific merchant partner and makes a purchase, the portable device will be entered into another instant win program automatically to win a similar prize.

The system also allows greater flexibility to customize prize offerings at the cardholder level because the system can have specific prizes that are awarded depending on a single or multiple selection criteria.

Also, by using central administrative host 106, multiple merchants can be engaged in related programs. Thus, a behavior network may be set up at the consumer level. For instance, a huge percentage of video rentals take place before or after they are shipped to grocery stores. Tying the two together for a promotional instant win program may offer new marketing opportunities for both the grocery stores and video rental stores.

The system and method may be implemented as a standalone process (instant win program) in combination with other transactions that would involve the holder and acceptor, holder and issuer, or any combination thereof. For example, an instant win program entry for every purchase of a good or an instant win program entry for every use of a credit card may be implemented. The system may also be implemented as a single application in the various parts of system 100 (portable device 102, base device 104, or administrative host 106). The system may also be combined with other applications, for example, a combination of a loyalty/instant win system where an instant win program entry is entered for every third purchase, a sweepstake entry where prizes are a function of customer status (first time, frequent customer, etc.)

It should be understood that the present invention as described above can be implemented in software, hardware, or a combination of both, in the form of control logic in a modular or integrated manner. Based on the disclosure and teachings provided herein, a person of ordinary skill in the art will appreciate other ways and/or methods to implement the present invention.

The above description is illustrative but not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

What is claimed is:

1. A method for providing an instant win program during a transaction between a base device and a portable device, the method comprising:
establishing a connection between the portable device and the base device to initiate the transaction between the portable device and base device;
determining information for the instant win program at the base device; and
using the information to determine if the portable device is eligible for a prize in the instant win program during the transaction.

2. The method of claim 1, wherein determining information comprises determining a reference parameter.

3. The method of claim 2, wherein determining information comprises determining an instant win program parameter.

4. The method of claim 3, wherein using the information to determine if the portable device is eligible for the prize comprises:
logically comparing the reference parameter and the instant win program parameter; and
determining the eligibility based on the comparison.

5. The method of claim 1, wherein the base device is associated with an operator and further comprising:
using the information to determine if the operator is eligible for another prize in the instant win program.

6. The method of claim 1, further comprising determining the prize for the instant win program.

7. The method of claim 6, further comprising determining a distribution method for distributing the prize.

8. The method of claim 7, wherein the distribution method comprises an immediate distribution method, a delayed distribution method, and a conditional distribution method.

9. The method of claim 7, further comprising storing information for the distribution method on the portable device using a secure method.

10. The method of claim 7, wherein the distribution method further comprises requiring a positive action by a user of the portable device in order for the user to receive the prize.

11. The method of claim 7, further comprising communicating distribution information for the distribution method to the portable device.

12. The method of claim 11, wherein the distribution information allows the portable device to redeem the prize.

13. The method of claim 1, further comprising communicating information for the prize to a user of the portable device.

14. The method of claim 1, further comprising communicating information for the transaction to an administrative host.

15. The method of claim 1, wherein the steps of determining information and determining the eligibility are performed by the portable device and the base device in a substantially off-line fashion.

16. The method of claim 15, wherein the transaction is at least one of a loyalty transaction, payment transaction, and transaction requiring the use of the portable device.

17. The method of claim 16, wherein the information used to determine if the portable device is eligible for the prize includes information relating to at least one of the loyalty transaction, payment transaction, and transaction requiring the use of the portable device.

18. The method of claim 1, wherein the portable device includes at least one of a smartcard, smartmedia card, a cellular phone, a personal digital assistant (PDA), a pager, a payment card, a security card, a transponder, and an access card.

19. The method of claim 1, wherein during a transaction between the portable device and the base device and wherein determining if the portable device is eligible for a prize in the instant win program comprises determining one or more prizes for a plurality of instant win programs; and further comprising:
distributing the one or more prizes.

20. The method of claim 1, wherein the base device includes at least one of a point of sale (POS) device, a cellular phone, a PDA, a computer, a handheld specialized reader, a set-top box, a kiosk, an electronic cash register (ECR), a virtual cash register (VCR), a security system, an automatic teller machine (ATM), and an access system.

21. A method for providing a loyalty program in conjunction with an instant win program, the method comprising:
processing one or more loyalty transactions associated with the loyalty program for a portable device;
determining if the portable device is eligible for the instant win program based on at least information associated with the one or more loyalty transactions; and
if eligible for the instant win program, determining, for the portable device, a result of the instant win program based on at least information related to the one or more loyalty transactions.

22. The method of claim 21, further comprising:
determining if the portable device is eligible for a loyalty incentive based on the result of at least the instant win program.

23. The method of claim 21, wherein determining the result comprises determining a reference parameter and determining an instant win program parameter; and further comprising:
logically comparing the reference parameter and the instant win program parameter; and
determining the result based on the comparison.

24. The method of claim 21, further comprising determining a prize for the instant win program in response to the result.

25. The method of claim 24, further comprising determining a distribution method for distributing the prize.

26. The method of claim 25, wherein the distribution method comprises an immediate distribution method, a delayed distribution method, and a conditional distribution method.

27. The method of claim 25, further comprising requiring a positive action by a user of the portable device in order for the user to receive the prize.

28. The method of claim 25, further comprising communicating distribution information for the prize to the portable device.

29. The method of claim 28, wherein the distribution information allows the portable device to redeem the prize.

30. The method of claim 25, further comprising storing information for the distribution method of the prize on the portable device using a secure method.

31. The method of claim 24, further comprising communicating information for the prize to a user of the portable device.

32. The method of claim 21, further comprising communicating information for the transaction to an administrative host.

33. The method of claim 21, wherein processing one or more loyalty transactions, determining if the portable device is eligible, and determining the result are performed by the portable device and the base device in a substantially off-line fashion.

34. The method of claim 21, wherein the portable device includes at least one of a smartcard, smartmedia card, a cellular phone, a personal digital assistant (PDA), a pager, a payment card, a security card, a transponder, and an access card.

35. The method of claim 21, wherein the base device includes at least one of a point of sale (POS) device, a cellular phone, a PDA, a computer, a handheld specialized reader, a set-top box, a kiosk, an electronic cash register (ECR), a virtual cash register (VCR), a security system, an ATM, and an access system.

36. A method for providing an instant win program during a transaction between a base device and a portable device, the method comprising:
determining a first parameter for the instant win program;
determining a second parameter for the instant win program;
logically comparing the first parameter and the second parameter;
determining, for the portable device, a result of the instant win program based on the comparison during the transaction at the base device.

37. The method of claim 36, wherein the first parameter is determined at least in part on information related to the portable device; and wherein the second parameter is determined at least in part on information related to the base device.

38. The method of claim 36, further comprising determining a prize for the instant win program based on the result.

39. The method of claim 36, further comprising determining a distribution method for distributing the prize.

40. The method of claim 39, wherein the distribution method comprise an immediate distribution method, a delayed distribution method, and a conditional distribution method.

41. The method of claim 39, further comprising requiring a positive action by a user of the portable device in order for the user to receive the prize.

42. The method of claim 39, further comprising distributing the prize based on the distribution method.

43. The method of claim 39, further comprising storing information for the distribution method of the prize on the portable device using a secure method.

44. The method of claim 36, further comprising communicating information about the transaction to an administrative host.

45. The method of claim 36, wherein the transaction is one or more loyalty transactions.

46. The method of claim 45, wherein the step of determining the result further comprises determining the result using information relating to the loyalty transaction.

47. The method of claim 36, further comprising using information from the transaction to determine an incentive for a loyalty program.

48. A base device for providing an instant win program during a transaction between the base device and a portable device, the base device comprising:
a communicator configured to communicate with the portable device to enable the transaction;
an information generator configured to retrieve information from the portable device and generate information for the transaction; and
a result generator configure to generate a result for the instant win program based on the generated information.

49. The base device of claim 48, further comprising a prize generator configured to determine a prize for the instant win program based on the result.

50. The base device of claim 49, further comprising a distribution method module configure to determine a distribution method for distributing the prize.

51. The base device of claim 48, further comprising a result communicator configured to communicate the result of the instant win program to an administrative host.

52. The base device of claim 48, further comprising a result communicator configured to communicate the result of the instant win program to the portable device.

53. The base device of claim 48, further comprising a security module configured to secure information associated with the instant win transaction.

54. The base device of claim 48, wherein the generated information is based on at least one of information retrieved from the portable device, information stored in the base device, and information from the transaction.

55. The base device of claim 48, wherein the information generator generates a reference parameter and an instant win program parameter, and wherein the result generator logically compares the reference parameter and the instant win parameter to generate the result.

56. The base device of claim 48, wherein the transaction is a loyalty transaction.

57. The base device of claim 48, further comprising a set of rules governing the operations of the instant win program.

58. The base device of claim 57, wherein the set of rules is uploaded to the base device by an administrative host.

59. The base device of claim 58, wherein when the set of rules is modified, the administrative host uploads the modified set of rules to the base device.

60. The base device of claim 48, further comprising storage for prior instant win program results that were loaded on the portable device.

61. The base device of claim 48, wherein the communicator is configured to communicate prior instant win program information to a user of the portable device, wherein the information allows customer service to be performed using the prior instant win information.

62. A system for providing an instant win program during a transaction, the system comprising:
a portable device; and
a base device configured to communicate with the portable device, the base device comprising:
logic to determine information for the instant win program; and
logic to use the information to determine if the portable device is eligible for a prize in the instant win program during the transaction.

63. The system of claim 62, wherein the transaction is one or more loyalty transactions.

64. The system of claim 63, wherein the information used to determine if the portable device is eligible for the prize includes information relating to the loyalty transaction.

65. The system of claim 62 wherein the base device further comprises:
logic to determine the prize for the instant win program.

66. The system of claim 62, wherein the information relating to the instant win program is used to determine an incentive earned by the portable device during a loyalty transaction.

67. The system of claim 62, wherein the base device further comprises:
logic to determine a distribution method for distributing the prize.

68. The system of claim 62, further comprising an administrative host;
wherein the base device is configured to communicate details for the transaction to the administrative host.

69. The system of claim 68, wherein the base device further comprises a plurality of rules governing operations of the instant win program, and wherein the administration host downloads the plurality of rules to the base device.

70. The system of claim 69, wherein when the plurality of rules of portions thereof are modified, the administrative host downloads the modified plurality of rules or portions thereof to the base device.

71. A method for providing an instant win program in a system using a plurality of portable devices and a plurality of base devices, the method comprising:
determining eligibility information for determining if a portable device in the plurality of portable devices is eligible for the instant win program;
determining result methods for use in determining if the portable device is eligible for a prize in the one or more instant win programs;
downloading the eligibility information and results methods to the plurality of base devices, the eligibility information and results methods being usable by a base device in the plurality of base devices to determine if a portable device in the plurality of portable devices is eligible for the instant win program and if the portable device is eligible for a prize in the one or more instant win programs.

72. The method of claim 71, further comprising:
determining distribution methods for distributing the prize for the one or more instant win programs; and
downloading the distribution methods to the plurality of base devices.

73. The method of claim 71, further comprising:
receiving a request for distribution of the prize to a user of the portable device; and
determining if the prize should be distributed to the user of the portable device upon the determination that the portable device is eligible for the prize and uploading the determination to the base device.

74. The method of claim 71, further comprising receiving the result of the determination if the portable device is eligible for the prize.

75. An administrative host for providing a plurality of instant win programs in a system using a plurality of portable devices and a plurality of base devices, the administrative host comprising:
an eligibility module configured to store eligibility information for determining if a portable device in the plurality of portable devices is eligible for the instant win program;
a result module configured to store result methods for use in determining if the portable device is eligible for a prize in the instant win program; and
a communicator configured to download the eligibility information and the results methods to the plurality of base devices, the eligibility information and the results methods being usable by a base device in the plurality of base devices to determine if a portable device in the plurality of portable devices is eligible for one or more instant win programs in the plurality of win programs during a transaction and if the portable device is eligible for a prize in the one or more instant win programs during the transaction.

76. The administrative host of claim 75, further comprising:
a fraud module configured to detect fraud in connection with the plurality of instant win programs.

77. The administrative host of claim 75, a distribution module configured to provide methods of distribution, wherein the communicator downloads the methods of distribution to the plurality of base devices.

78. The administrative host of claim 75, further comprising a billing module configured to receive information for the transaction and to settle the transaction with one or more entities associated with the one or more instant win programs.

79. The administrative host of claim 75, further comprising a reporting module configured to report information for the transaction and the one or more instant win programs to one or more entities associated with the one or more instant win programs.

80. The administrative host of claim 75, wherein the transaction is one or more loyalty transactions.

81. A base device for providing a plurality of loyalty programs in conjunction with a plurality of instant win programs, the base device comprising:
a loyalty module configured to process one or more loyalty transactions associated with a loyalty program in the plurality of loyalty programs for a portable device;
an information generator configured to determine information from the processing of the one or more loyalty transactions; and
an instant win program module configured to determine, for the portable device, a result of an instant win program in the plurality of instant win programs based on the determined information.

82. The base device of claim 81, further comprising a prize generator configured to determine a prize for the instant win program based on the result.

83. The base device of claim 81, further comprising an incentive generator configured to determine an incentive for the loyalty program based on the result of the instant win program.

84. The base device of claim 81, further comprising a result communicator configured to communicate the result of the instant win program to an administrative host.

85. The base device of claim 81, further comprising an interface configured to communicate the result to a user of the portable device.

86. The base device of claim 81, further comprising an interface configured to allow user of a portable device to fulfill conditions required for distribution of a prize.

87. A portable device for use in one or more instant win programs, the portable device comprising:
information usable to enable participation in the one or more instant win programs; and
logic to allow the base device to determine from the information if the portable device is eligible to participate in a transaction for an instant win program in the one or more instant win programs and if the portable device is eligible for a prize in the instant win program.

88. The portable device of claim 87, further comprising storage for storing information relating to the instant win transaction.

89. The portable device of claim 87, wherein the information includes information unique to the portable device.

90. The portable device of claim 87, wherein the information is usable to allow participation in one or more loyalty programs.

91. The portable device of claim 87, further comprising storage for storing information for a distribution method determined by the base device.
